(19) United States
(12) Patent Application Publication
(10) Pub. No.: US 2022/0316513 A1
(43) Pub. Date: Oct. 6, 2022

(54) Fastener

(71) Applicant: William Norton, West Pittston, PA (US)

(72) Inventor: William Norton, West Pittston, PA (US)

(21) Appl. No.: 17/221,084

(22) Filed: Apr. 2, 2021

(51) Int. Cl. F16B 25/00

(52) U.S. Cl. CPC F16B 25/0057

(57) ABSTRACT

A fastener has a head with a plurality of recesses. Each recess is defined by opposed side surfaces and a floor surface. One or both side surfaces of each recess may be formed of a lower facet which is oriented at an obtuse angle to the floor surface, and an upper facet which is oriented at an acute angle with respect to the floor surface.

### FIELD OF THE INVENTION

This invention relates to threaded fasteners and drivers compatible with such fasteners.

### BACKGROUND

Anyone who has driven threaded fasteners has, at some time, unintentionally stripped the head of a fastener, i.e. deformed the slots or recesses in the head so that it is no longer possible to apply torque to the fastener with a driving tool. A threaded fastener with a stripped head causes any number of well-known difficulties and it is desirable to avoid this situation. While it is possible to strip a head with a manual tool such as a common screwdriver, head stripping is more likely to occur, and occur frequently, when a power tool is used to rotate the driver. It is not always possible to apply sufficient axial force to the tool to maintain the driver engaged with the head of the fastener to deliver the torque necessary to turn and advance it. Power tools, with their capability for high rotational speed and significant torque can very rapidly ruin the head of any fastener as the tool turns against the head, riding in an out of the slots or recesses, without turning the fastener. It is furthermore very difficult to remove a fastener having a stripped head or threads. There is clearly a need for a combination driver and threaded fastener which mitigates the potential for damaging the head of the fastener by stripping and also permits ready removal of fasteners having stripped threads.

### SUMMARY

The invention concerns a fastener. In one example embodiment the fastener comprises a shaft having a coaxial longitudinal axis. Helical threads extend around at least a portion of the shaft. A head is mounted on the shaft. The head has a plurality of recesses extending outwardly from the longitudinal axis. Each recess is defined by first and second oppositely disposed side surfaces, and a floor surface extending therebetween. For each recess the first side surface comprises a first lower facet contiguous with the floor surface. The first lower facet is oriented at an obtuse angle relatively to the floor surface. A first upper facet extends between the first lower facet and a top opening of the recess, the first upper facet being oriented at an acute angle relatively to the floor surface. By way of example the acute angles may vary with distance from the longitudinal axis. In a specific example the acute angles become smaller with increasing distance from the longitudinal axis.

By way of example a minimum value of the acute angles ranges from 15° to 60° and a minimum value of the acute angles of 30° is considered advantageous. Further by way of example a minimum value of the obtuse angles ranges from 110° to 165° and a minimum value of the obtuse angles of 135° is considered advantageous.

In an example embodiment the floor surface is angularly oriented with respect to the longitudinal axis. In a specific example, the floor surface has an orientation angle ranging from 50° to 90° and an orientation angle of 70° is considered advantageous.

Each recess in an example embodiment the floor surface may have a first width proximate to the longitudinal axis and a second width distal to the longitudinal axis wherein the second width is greater than the first width. Further by way of example, for each recess, an edge of the first upper facet proximate to the longitudinal axis may be oriented parallel thereto.

By way of example, for each recess, the second side surface comprises a second lower facet contiguous with the floor surface. The second lower facet is oriented at an obtuse angle relatively to the floor surface. A second upper facet extends between the second lower facet and the top opening of the recess. The second upper facet is oriented at an acute angle relatively to the floor surface. The acute angles of the second upper facets vary with distance from the longitudinal axis. In an example embodiment the acute angles of the second upper facets become smaller with increasing distance from the longitudinal axis. In a specific example a minimum value of the acute angles of the second upper facets ranges from 15° to 60° and a minimum value of the acute angles of the second upper facets of 30° is considered advantageous. Further by way of example, a minimum value of the obtuse angles of the second lower facets ranges from 110° to 165° and a minimum value of the obtuse angles of the second lower facets of 135° is considered advantageous.

In an example embodiment, for each recess, an edge of the second upper facet proximate to the longitudinal axis may be oriented parallel thereto. An example embodiment may comprise three of the recesses or may comprising four of the recesses. Each recess may further comprise a respective end wall extending between the first and second oppositely disposed side surfaces by way of example. Also in an example embodiment, for each recess a portion of the second side surface defines a single plane extending from a top opening of each recess. In an example, for each recess, the portion of the second side surface may be oriented at an obtuse angle with respect to the floor surface. In a specific example, a value of the obtuse angle of the second side surface ranges from 105° to 150° and a value of the obtuse angle of the second surface of 120° is considered advantageous.

The invention further encompasses a fastener, which, by way of example comprises a shaft having a coaxial longitudinal axis. Helical threads extend around at least a portion of the shaft. A head is mounted on the shaft. The head has a plurality of recesses extending outwardly from the longitudinal axis. Each recess is defined by first and second oppositely disposed side surfaces and a floor surface extending between them. For each recess the first side surface comprises a first lower facet contiguous with the floor surface. The first lower facet is oriented at an obtuse angle relatively to the floor surface. A first upper facet extends between the first lower facet and a top opening of the recess. The first upper facet is oriented at an acute angle relatively to the floor surface. For each recess the second side surface comprises a second lower facet contiguous with the floor surface. The second lower facet is oriented at an obtuse angle relatively to the floor surface. A second upper facet extends between the second lower facet and the top opening of the recess. The second upper facet is oriented at an acute angle relatively to the floor surface. In an example embodiment the acute angles for the first and second upper facets may vary with distance from the longitudinal axis. Specifically by way of example, the acute angles for the first and second upper facets may become smaller with increasing distance from the longitudinal axis. A minimum value of the acute angles for the first and second upper facets may range from 15° to 60° and a minimum value of the acute angles for the first and second upper facets of 30° is considered advantageous. By way of example, a minimum value of the obtuse angles for the first and second lower facets may range from 110° to 165° and a minimum value of the obtuse angles for the first and second lower facets of 135° is considered advantageous.

Further by way of example the floor surface may be angularly oriented with respect to the longitudinal axis. In an example embodiment the floor surface may have an orientation angle ranging from 50° to 90° and an orientation angle of 70° is considered advantageous. Also by way of example, for each recess, the floor surface may have a first width proximate to the longitudinal axis and a second width distal to the longitudinal axis wherein the second width is greater than the first width. In an example embodiment, for each recess, an edge of the first upper facet proximate to the longitudinal axis may be oriented parallel thereto and an edge of the second upper facet proximate to the longitudinal axis may be oriented parallel thereto.

An example fastener embodiment may comprise three of the recesses wherein the recesses are distributed about the longitudinal axis at angles of 120° from one another about the longitudinal axis. Also by way of example the fastener according to the invention may comprising four of the recesses distributed about the longitudinal axis at angles of 90° from one another about the longitudinal axis. In an example embodiment, each recess may further comprise a respective end wall extending between the first and second oppositely disposed side surfaces.

The invention further encompasses a tool for forming a plurality of recesses in the head of a fastener. In an example embodiment the tool comprises a base. A plurality of projections extendi proud of the base. The projections radiate from a central axis oriented transversely to the base. In an example each projection comprises a bottom surface facing away from the base. A first side surface extends from the bottom surface to the base. The first side surface comprises a lower portion contiguous with the bottom surface and an upper portion extending between the lower portion and the base. By way of example, the upper portion is oriented at an acute angle with respect to the bottom surface. In an example embodiment each bottom surface may have a polygonal shape. A vertex of each bottom surface may be coincident with the central axis and form an apex. In an example tool according to the invention, each bottom surface has a triangular shape. Further by way of example, each bottom surface may be oriented at an acute angle with respect to the central axis.

The invention also includes a method of manufacturing an example fastener according to the invention, the fastener having a shaft, a head positioned at one end of the shaft, and a longitudinal axis extending lengthwise along the shaft. In an example embodiment, the method comprises deforming the head by forming a plurality of recesses therein, each of the recesses extending transversely to the longitudinal axis and being defined by first and second side surfaces in spaced relation to one another, and a floor surface extending therebetween. In an example method, deforming the first side surfaces of each of the recesses such that each first side surface comprises a first lower facet contiguous with the floor surface, the first lower facet being oriented at an obtuse angle relatively to the floor surface, and a first upper facet extending between the first lower facet and a top opening of the recess, the first upper facet being oriented at an acute angle relatively to the floor surface.

An example method according to the invention may further comprise deforming the second side surfaces of each of the recesses such that each second side surface comprises a second lower facet contiguous with the floor surface, the second lower facet being oriented at an obtuse angle relatively to the floor surface and a second upper facet extending between the second lower facet and the top opening of the recess, the second upper facet being oriented at an acute angle relatively to the floor surface.

Further by way of example, in a method according to the invention, deforming the first side surfaces of the recesses comprises compressing the head along the longitudinal axis using a tool while rotating the tool about the longitudinal axis in a first direction. Also by way of example, deforming the first side surfaces of the recesses comprises compressing the head along the longitudinal axis using a first tool while rotating the first tool about the longitudinal axis in a first direction, and deforming the second side surfaces of the recesses comprises compressing the head along the longitudinal axis using a second tool while rotating the second tool about the longitudinal axis in a second direction opposite to the first direction. An example method according to the invention may further comprise forming a plurality of helical threads around at least a portion of the shaft.

### BRIEF DESCRIPTION OF THE DRAWINGS

FIG. 1 is an isometric view of an example embodiment of a fastener according to the invention;

FIG. 1A is an isometric view of another example embodiment of a fastener according to the invention;

FIG. 2 is a partial sectional side view of the fastener shown in FIG. 1;

FIG. 3 is a partial sectional isometric view of the fastener shown in FIG. 1;

FIG. 4 is an isometric view of a portion of another example embodiment of a fastener according to the invention;

FIG. 4A is an isometric view of another example embodiment of a fastener according to the invention;

FIG. 5 is a partial sectional isometric view of the fastener shown in FIG. 4;

FIG. 6 is a partial sectional isometric view of the fastener shown in FIG. 4;

FIGS. 7 and 8 are partial sectional side views showing an example fastener according to the invention being used with a compatible driver;

FIGS. 9 and 10 are respective isometric views of right and left hand tools used to manufacture fasteners according to the invention; and

FIGS. 11-23 illustrate steps of an example method for manufacturing fasteners according to the invention.

### DETAILED DESCRIPTION

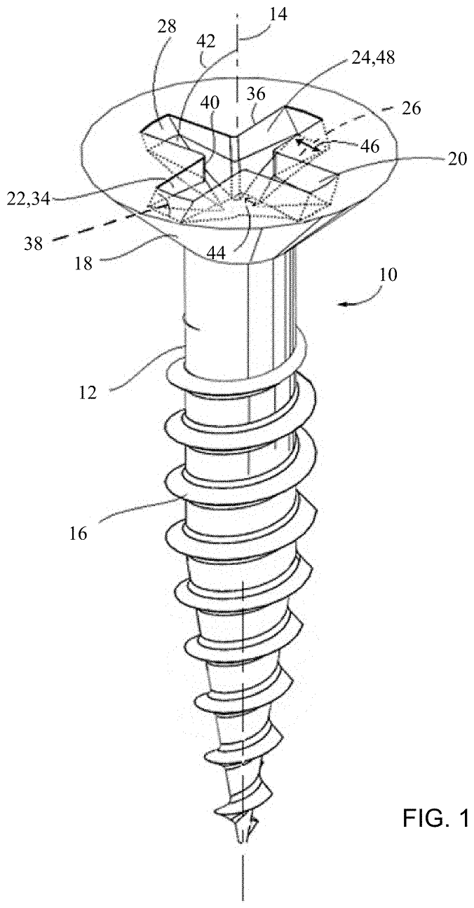

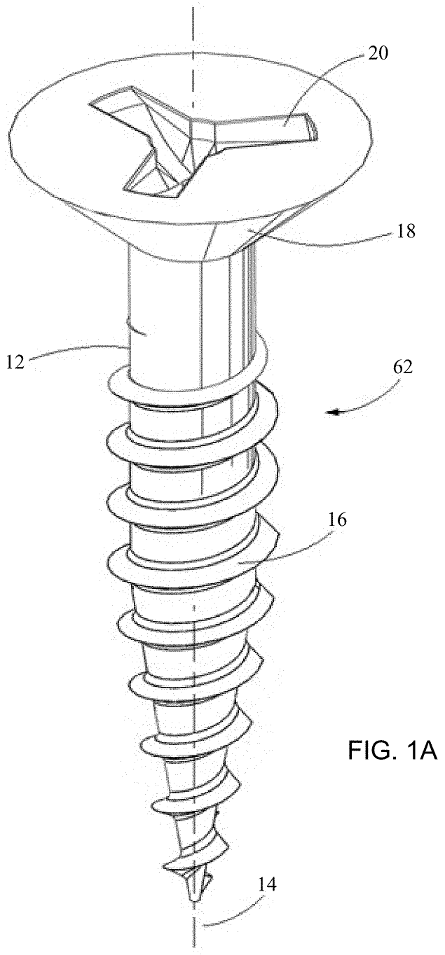

FIG. 1 shows an example embodiment of a fastener 10 according to the invention. Fastener 10 comprises a shaft 12 having a coaxial longitudinal axis 14. Helical threads 16 extend around at least a portion of the shaft 12. A head 18 is mounted on the shaft 12. Head 18 has a plurality of recesses 20 extending outwardly from the longitudinal axis. Each recess 20 is defined by first and second oppositely disposed side surfaces 22 and 24 respectively, and a floor surface 26 extending between the side surfaces. In this example each recess 20 further comprises a respective end wall 28 extending between the first and second oppositely disposed side surfaces 22 and 24.

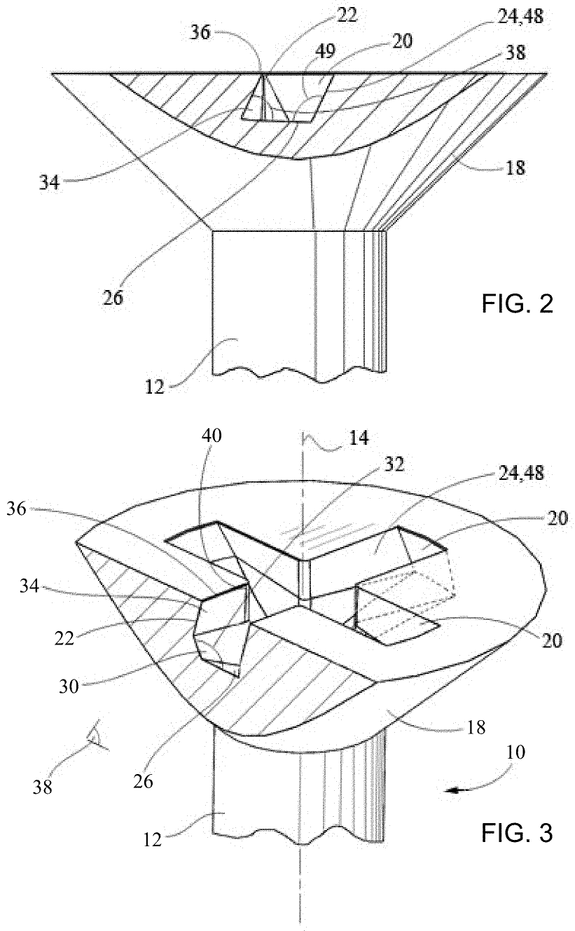

As shown in FIG. 3, for each recess 20, the first side surface 22 comprises a first lower facet 30 contiguous with the floor surface 26. The first lower facet 30 is oriented at an obtuse angle 32 relatively to the floor surface 26. First side surface 22 further comprises a first upper facet 34 extending between the first lower facet 30 and a top opening 36 of the recess 20. As further shown in FIGS. 2 and 3, the first upper facet 34 is oriented at an acute angle 38 relatively to the floor surface 26. Review of FIGS. 1 and 3 shows that the acute angle 38 of the first upper facet 34 may vary with distance from the longitudinal axis 14. In this example embodiment an edge 40 of the first upper facet 34 proximate to the longitudinal axis 14 is oriented substantially parallel thereto and the acute angle 38 of the first upper facet 34 becomes smaller with increasing distance from the longitudinal axis 14.

In a practical design of a fastener according to the invention, a minimum value of the acute angle for the first upper facets 34 ranges from about 15° to about 60°, and a minimum value of about 30° may be advantageous for some applications. In a further practical example, a minimum value of the obtuse angle 32 for the first lower facets 30 ranges from about 110° to about 165°, and a minimum value of about 135° may be advantageous for some applications.

As shown in FIG. 1, the floor surface 26 in each recess 20 may be angularly oriented with respect to the longitudinal axis 14. In a practical design, the floor surface 26 may have an orientation angle 42 ranging from about 50° to about 90° wherein an orientation angle of about 70° is considered advantageous for some applications. Additionally for each recess 20, the floor surface 26 may have a first width 44 proximate to the longitudinal axis 14 and a second width 46 distal to the longitudinal axis wherein the second width is greater than the first width.

As shown in FIGS. 2 and 3, for each recess 20 in fastener embodiment 10, a portion of the second side surface 24 defines a single plane 48 extending from the top opening 36 of each recess. As shown in FIG. 2, the plane 48 may also be oriented at an obtuse angle 49 with respect to floor surface 26. Obtuse angle 49 may range from about 105° to about 120°, and a value of about 150° may be considered advantageous for certain applications. The embodiment of fastener 10 is advantageous because it simplifies manufacture and, depending upon orientation angle 49, may also serve as a “security screw” wherein extraction by applying reverse torque to the fastener is inhibited.

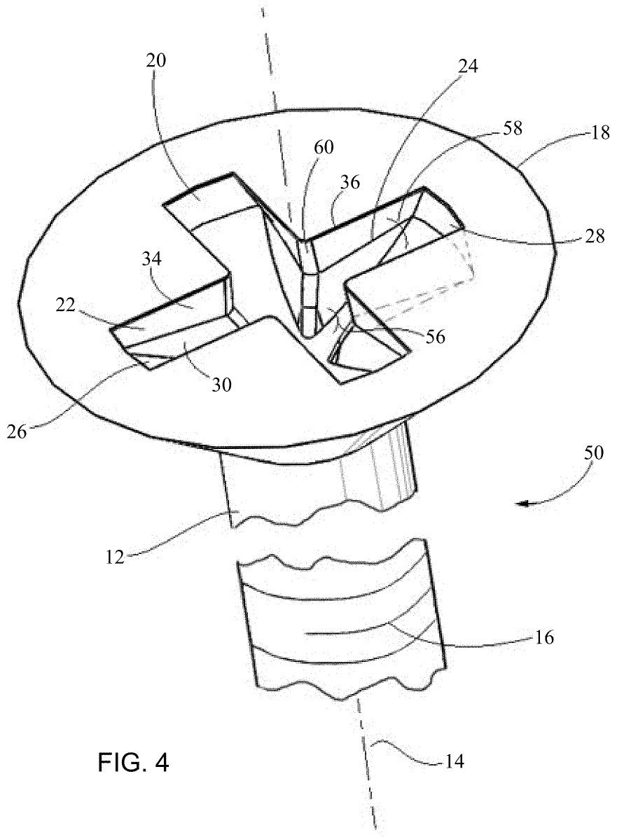

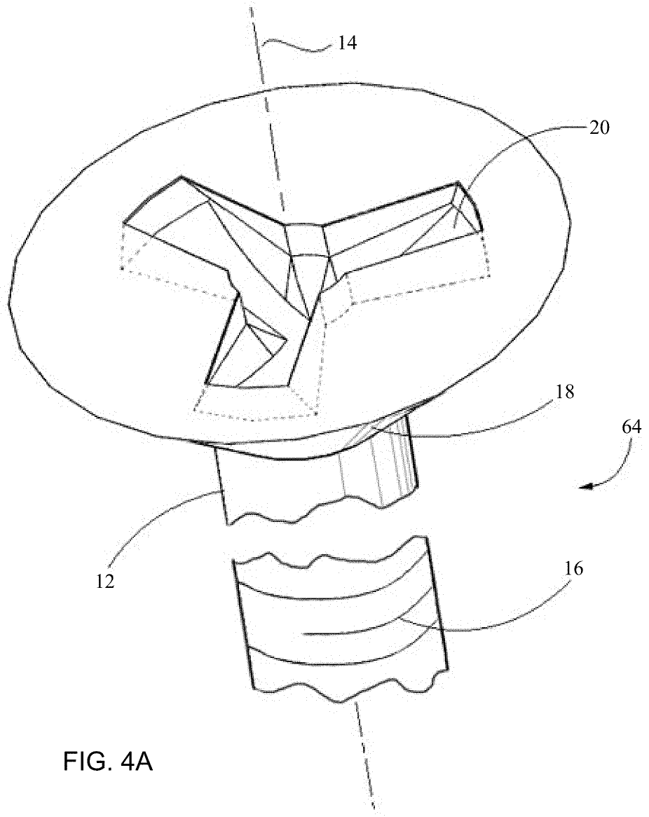

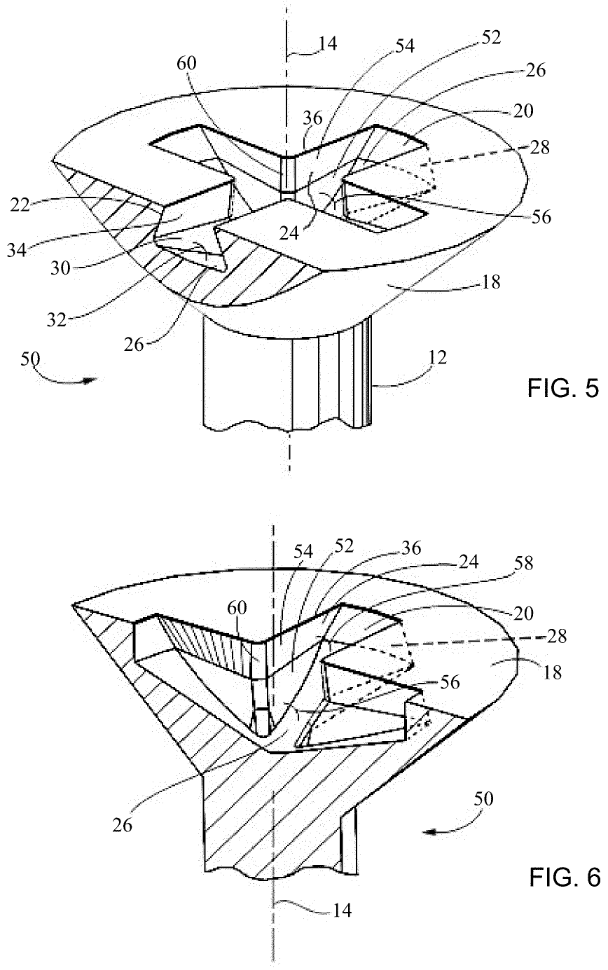

FIGS. 4, 5 and 6 illustrate another example fastener embodiment 50 according to the invention. The recesses 20 of fastener 50 are similar to those of fastener 10 in that the first side surfaces 22 are comprised of first lower and upper facets 30 and 34 as described above, but, for each recess, the second side surface 24 comprises a second lower facet 52 and a second upper facet 54. Second lower facet 52 is contiguous with the floor surface 26 and is oriented at an obtuse angle 56 relatively to it. Second upper facet 54 extends between the second lower facet 52 and the top opening 36 of the recess 20. The second upper facet 54 is oriented at an acute angle 58 relatively to the floor surface 26. As shown in FIG. 6, the acute angles 58 of the second upper facets 54 vary with distance from the longitudinal axis 14 and in this example become smaller with increasing distance from the longitudinal axis. In a practical design, a minimum value of the acute angles 58 of the second upper facets 54 ranges from about 15° to about 60° and a minimum value of the acute angles of the second upper facets may be about 30° for some applications. In a further practical example, a minimum value of the obtuse angles 56 of the second lower facets 52 ranges from about 110° to about 165°, wherein a minimum value may be 135° for some applications. Similar to fastener 10, for each recess 20 in fastener 50, an edge 60 of the second upper facet 54 proximate to the longitudinal axis 14 is oriented substantially parallel thereto.

FIGS. 1 and 4 illustrate fasteners 10 and 50, each of which comprises 4 recesses 20 distributed about the longitudinal axis 14 at angles of 90° from one another. Embodiments having more or fewer recesses are also feasible, as shown, for example, in FIGS. 1A and 4A, which depict fasteners 62 and 64, each comprising three of the recesses 20 wherein the recesses are distributed about the longitudinal axis 14 at angles of 120° from one another. The recesses 20 of fastener 62 are the same as those of fastener 10 whereas the recesses 20 of fastener 64 are the same as those of fastener 50.

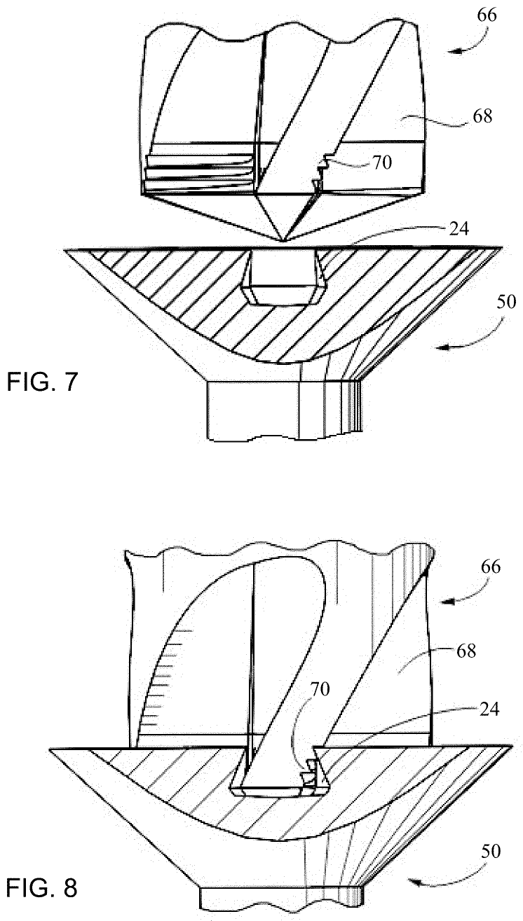

FIGS. 7 and 8 illustrate fastener 50 used with a compatible driver 66 having helical blades 68 with teeth 70 as disclosed in U.S. patent application Ser. No. 17/204,985, filed Mar. 18, 2021 and hereby incorporated by reference herein. FIG. 7 shows driver 66 approaching the head 18 of fastener 50. Once seated within recesses 20, rotation of the driver according to the right hand rule will advance right handed threads of fastener 50 into a work piece. FIG. 8 illustrates the use of teeth 70 which engage the second side surfaces 24 of recesses 20 to withdraw the fastener 50 when the driver is counter rotated. Note that for fastener 10, withdrawal via counter rotation of the driver 66 would be more difficult, if not impossible, depending on the angular orientation of second side surface 24.

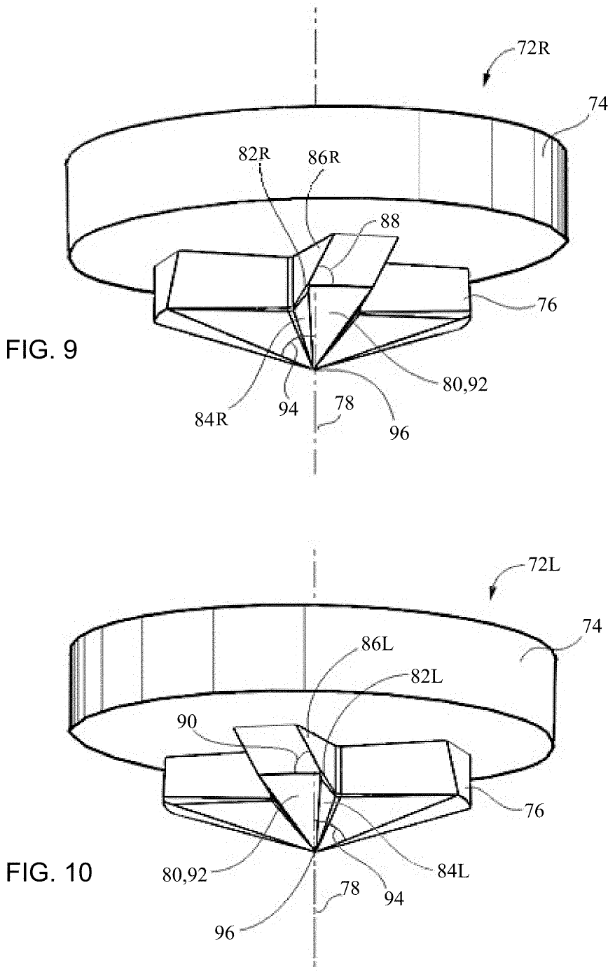

The invention also encompasses tools for forming a plurality of recesses in the head of a fastener. FIGS. 9 and 10 show example first and second tools 72R (right hand tool) and 72L (left hand tool) which can be used to manufacture both example fasteners 10 and 50. In the example depicted, each tool 72R and 72L comprises a base 74. A plurality of projections 76 extend proud of the base 74. The projections 76 radiate from a central axis 78 oriented transversely to the base 74. Each projection 76 comprises a bottom surface 80 facing away from the base 74. As shown in FIG. 9, a first side surface 82R extends from the bottom surface 80 to the base 74. The first side surface 82R comprises a lower portion 84R contiguous with the bottom surface 80, and an upper portion 86R extending between the lower portion 84R and the base 74. The upper portion 86R of right hand tool 72R is oriented at an acute angle 88 with respect to the bottom surface 80. Similarly, as shown in FIG. 10, the first side surface 82L of left hand tool 72L comprises a lower portion 84L contiguous with the bottom surface 80 and an upper portion 86L extending between the lower portion 84L and the base 74. The upper portion 86L of the left hand tool 72L is oriented at an acute angle 90 with respect to the bottom surface 80. Note that the right and left hand tools 72R and 72L are distinguished by their first side surfaces 82R and 82L being on opposite sides of the projections 76. As explained below, right hand tool 72R turns in a direction which advances its first side surface 82R into a work piece, and left hand tool 72L turns in the opposite direction to advance its first side surface 82L into a work piece.

Each bottom surface 80 may have a polygonal shape 92, for example, triangular. Each bottom surface may be oriented at an acute angle 94 with respect to the central axis 78. Vertices of each bottom surface 80 are advantageously coincident with the central axis 78 to form a tool apex 96.

The angles 88 and 90 of the upper portions 86R, 86L of the respective first side surfaces 82R, 82L are determined by the desired angles of the upper facets 34 and 54 in the first and second side surfaces 22 and 24 of the recesses 20 to be formed in the head 18 when tools 72R and 72L are impressed into a blank during forming of fasteners 10 and 50 as described below.

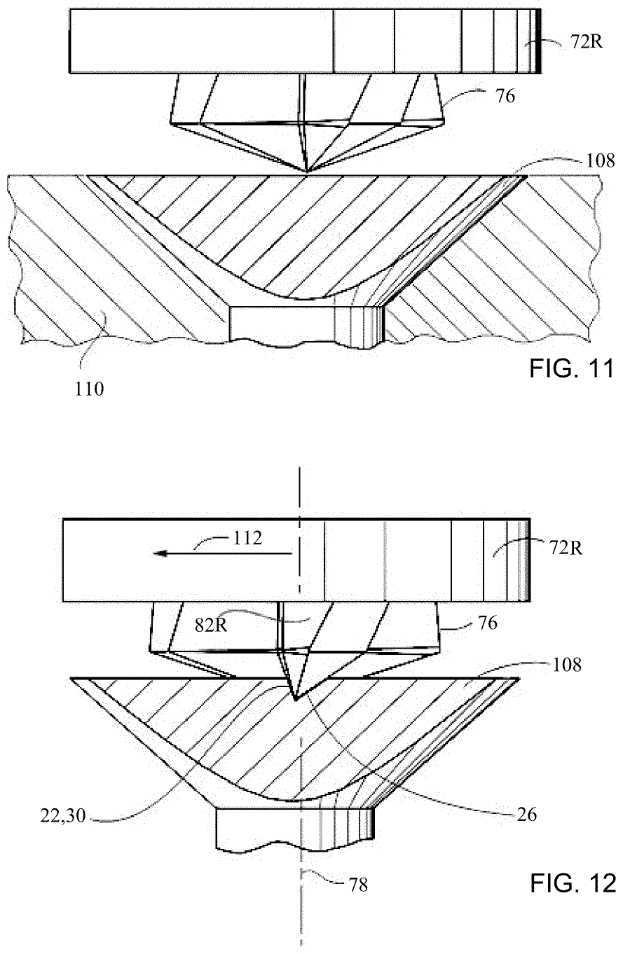

FIGS. 11-17 illustrate an example method of manufacturing fastener 10. As described above and shown in FIG. 1, fastener 10 has a shaft 12, a head 18 positioned at one end of the shaft, and a longitudinal axis 14 extending lengthwise along the shaft. In the example embodiment illustrated the method comprises using the tool 72R to deform the head 18 by forming a plurality of the recesses 20 therein. Each of the recesses 20 extends transversely to the longitudinal axis and is defined by first and second side surfaces 22 and 24 in spaced relation to one another. A floor surface 26 extends between the side surfaces 22 and 24.

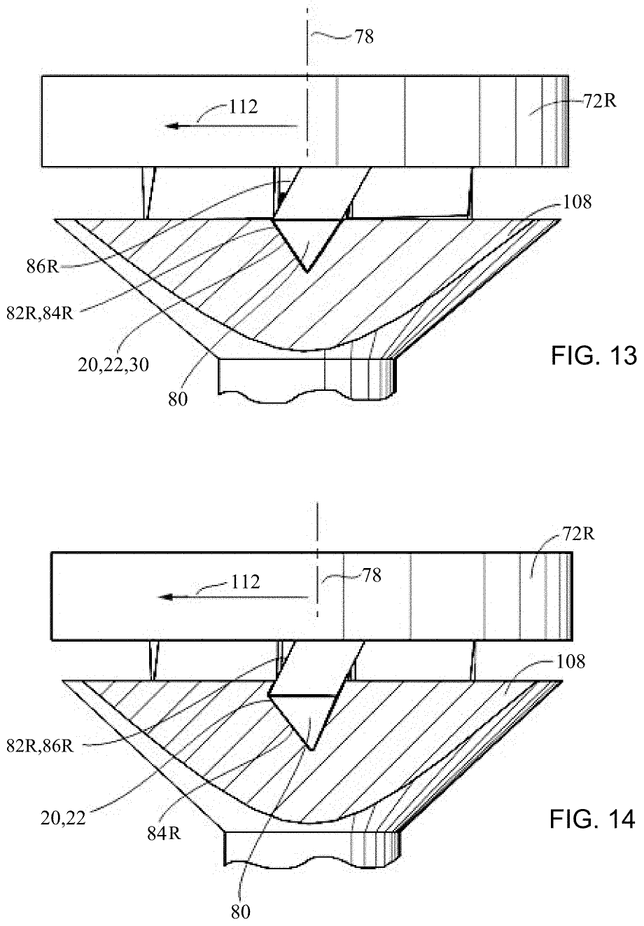

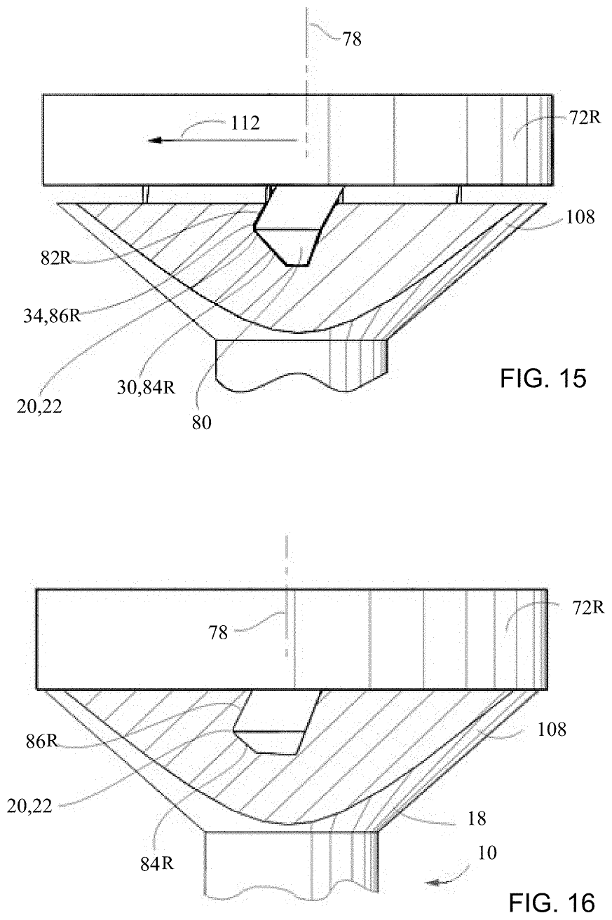

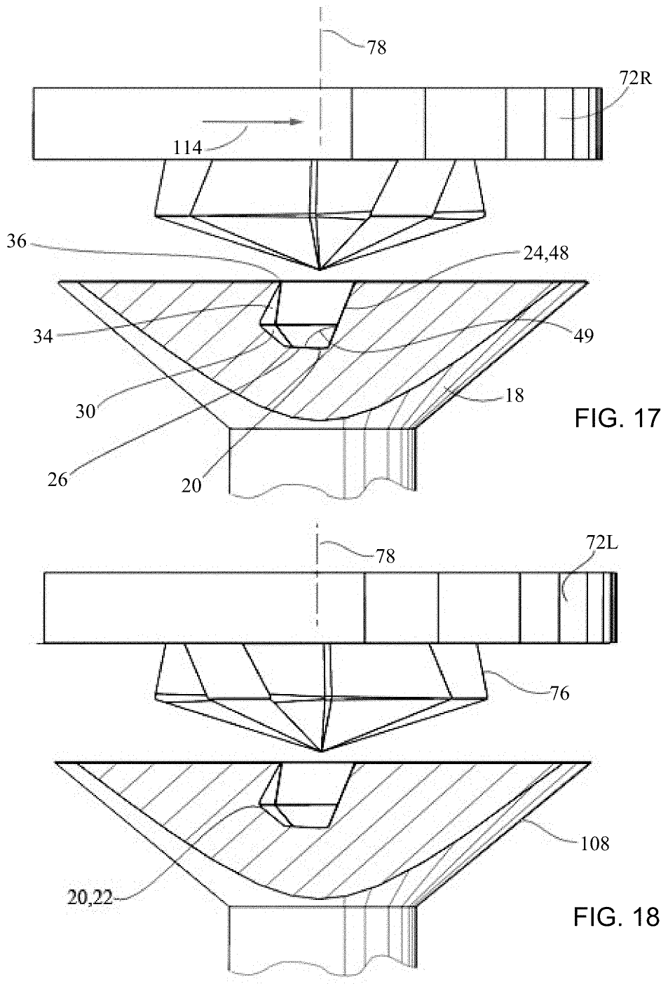

As shown in FIG. 11, a fastener blank 108 is captured within a die 110 (shown only in FIG. 11). Right hand tool 72R is shown approaching the blank 108. FIG. 12 shows the projections 76 of tool 72R compressing and deforming the blank 108 to create the first side surfaces 22 of each of the recesses 20 in the head 18 (see also FIG. 1). FIG. 12 shows engagement of the tool 72R as it begins to form the first lower facet 30 and the floor surface 26. As tool 72R compresses the blank 108 it is rotated about its central axis 78 in a first direction according to the right hand rule to advance a screw with right handed threads and thus turns in a direction which advances its first side surface 82R into the blank 108 as shown by arrow 112. FIG. 13 shows further engagement of the tool 72R with the lower portion 84r of its first side surface 82R fully engaged with the blank 108. The bottom surface 80 is in view head on and forms the floor surface 26 of recesses 20 as it sweeps through the blank 108. Continued rotation and advancement of tool 72R into the blank 108 as shown in FIGS. 14 and 15 engages the upper portion 86R of the first sides 82R of projections 76 with the blank 108 to begin forming the first upper facet 34 of the first side surface 22 of recesses 20. FIG. 16 shows tool 72R fully engaged, completing the formation of the first side surfaces 22 of recesses 20 in what is now the head 18 of the fastener 10. As shown in FIG. 17, tool 72R is rotated in the direction indicated by arrow 114 and withdrawn from engagement with the head 18, leaving a plurality of recesses 20 having lower facets 30 upper facets 34 extending between the lower facets and a top opening 36 of the recesses.

As FIGS. 11-17 illustrate manufacture of fastener embodiment 10, the tool 72R has also deformed the second side surfaces 24 of each of the recesses 20 such that a portion of the second side surfaces define single respective planes 48 which extend from the top opening 36 of the recesses and which are oriented at an obtuse angle 49 relatively to the floor surfaces of the recesses.

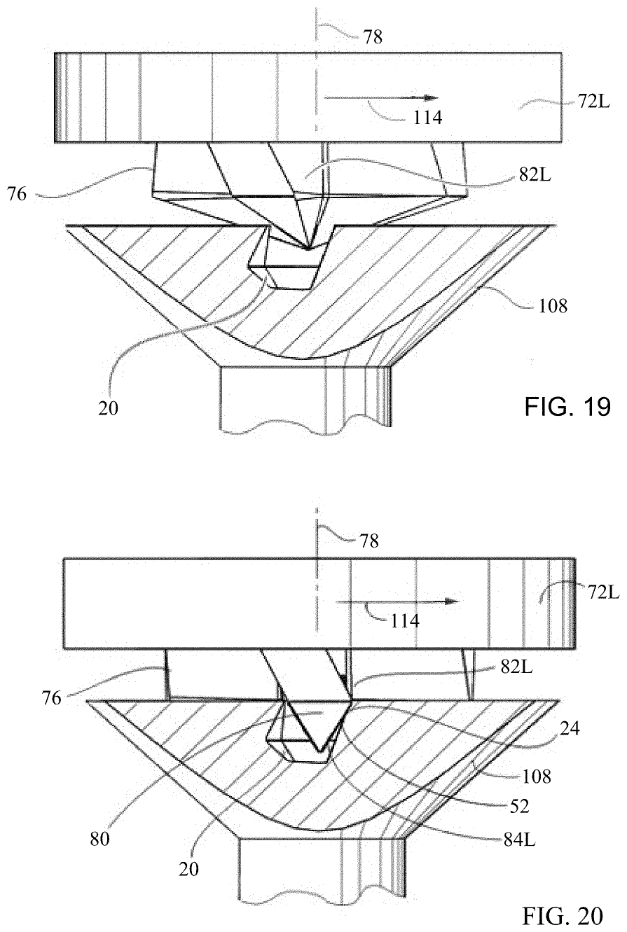

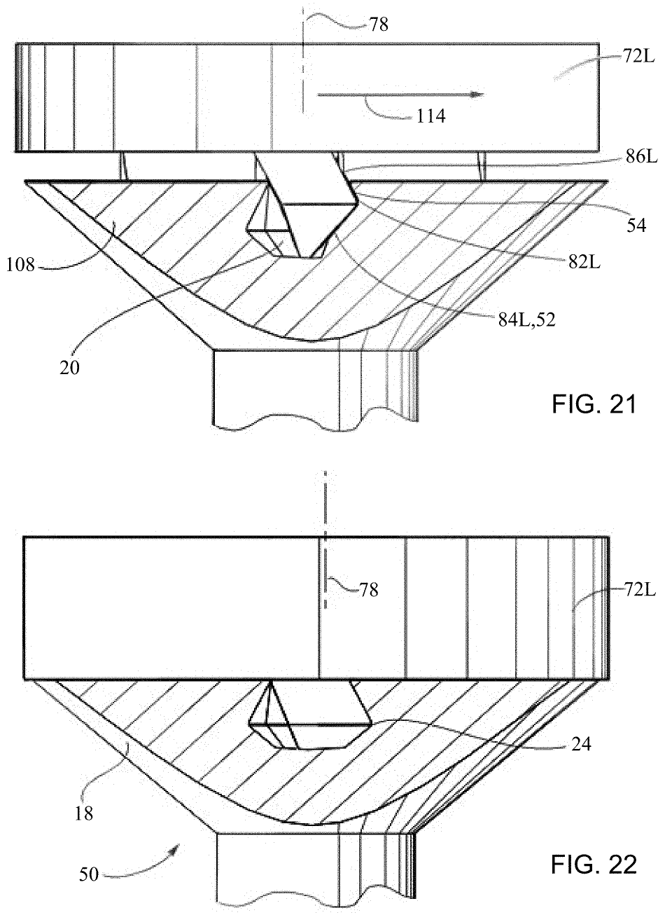

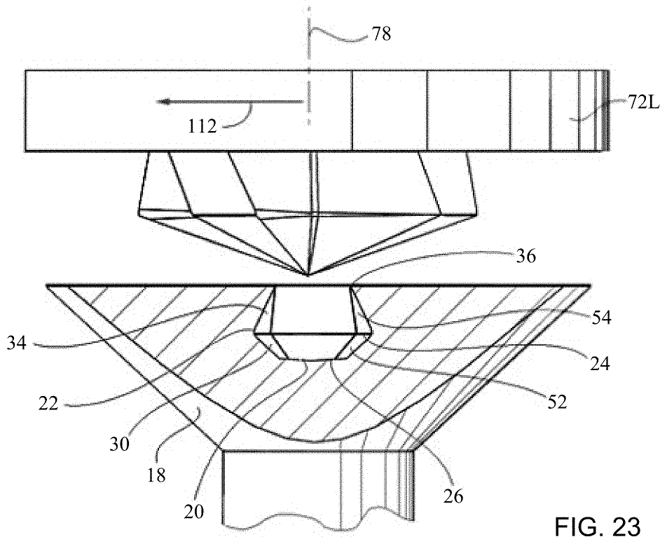

Manufacture of fastener embodiment 50 is illustrated in FIGS. 11-23 and comprises deforming the both the first and second side surfaces 22 and 24 of each of the recesses 20 using the right and left hand tools 72R and 72L. Thus the method entails the actions described above using tool 72R and illustrated in FIGS. 11-17 followed by the steps illustrated in FIGS. 18-23 using tool 72L. As shown in FIG. 18, the left hand tool 72L approaches the partially formed blank 108. As shown in FIG. 19, the tool 72L advances into the blank 108 and rotates about axis 78 in the direction of arrow 114 to advance its first side surface 82L into blank 108. FIG. 20 shows deeper engagement of the tool 72L into the recesses 20 wherein the lower portions 84L of the side surfaces 82L of the projections 76 begin to engage the blank 108 to form the lower facets 52 of the second side surfaces 24 of fastener 50 (see also FIG. 4). Bottom surfaces 80 of the projections 76 which will form the floor surfaces 26 is shown head on in this view. FIG. 21 shows continued advancement and rotation of tool 72L about axis 78 wherein the upper portions 86L of the side surfaces 82L of projections 76 begin to engage the blank 108 and form the second upper facets 54 of the recesses 20. FIG. 22 shows the tool 72L fully engaged and completing the formation of the second side surfaces 24 in what is now the head 18 of fastener 50. As shown in FIG. 23, tool 72L is rotated about axis 78 in the direction indicated by arrow 112 and withdrawn from engagement with the head 18, leaving a plurality of recesses 20 having first and second side surfaces 22 and 24 with respective first and second lower facets 30 and 52 and respective first and second upper facets 34 and 54 extending between the first lower facets and a top openings 36 of the recesses 20.

Fasteners 10 and 50 may be completed by forming a plurality of helical threads around at least a portion of their shafts 12. This can be accomplished by swaging the shaft 12 while the blank 108 is captured within die 110, or by swaging the shaft in a separate operation, or by machining the shaft on a screw forming lathe as is well understood.

1. A fastener, said fastener comprising:
a shaft having a coaxial longitudinal axis;
helical threads extending around at least a portion of said shaft;
a head mounted on said shaft, said head having a plurality of recesses extending outwardly from said longitudinal axis, each said recess being defined by first and second oppositely disposed side surfaces, and a floor surface extending therebetween, wherein for each said recess, said first side surface comprises:
a first lower facet contiguous with said floor surface, said first lower facet being oriented at an obtuse angle relatively to said floor surface;
a first upper facet extending between said first lower facet and a top opening of said recess, said first upper facet being oriented at an acute angle relatively to said floor surface.

2. The fastener according to claim 1, wherein said acute angles vary with distance from said longitudinal axis.

3. The fastener according to claim 2, wherein said acute angles become smaller with increasing distance from said longitudinal axis.

4. The fastener according to claim 2, wherein a minimum value of said acute angles ranges from 15° to 60°.

5. The fastener according to claim 2, wherein a minimum value of said acute angles is 30°.

6. The fastener according to claim 1, wherein a minimum value of said obtuse angles ranges from 110° to 165°.

7. The fastener according to claim 1, wherein a minimum value of said obtuse angles is 135°.

8. The fastener according to claim 1, wherein said floor surface is angularly oriented with respect to said longitudinal axis.

9. The fastener according to claim 8, wherein said floor surface has an orientation angle ranging from 50° to 90°.

10. The fastener according to claim 8, wherein said floor surface has an orientation angle of 70°.

11. The fastener according to claim 1, wherein for each said recess, said floor surface has a first width proximate to said longitudinal axis and a second width distal to said longitudinal axis, said second width being greater than said first width.

12. The fastener according to claim 2, wherein, for each said recess, an edge of said first upper facet proximate to said longitudinal axis is oriented parallel thereto.

13. The fastener according to claim 1, wherein for each said recess said second side surface comprises:
a second lower facet contiguous with said floor surface, said second lower facet being oriented at an obtuse angle relatively to said floor surface;
a second upper facet extending between said second lower facet and said top opening of said recess, said second upper facet being oriented at an acute angle relatively to said floor surface.

14. The fastener according to claim 13, wherein said acute angles of said second upper facets vary with distance from said longitudinal axis.

15. The fastener according to claim 13, wherein said acute angles of said second upper facets become smaller with increasing distance from said longitudinal axis.

16. The fastener according to claim 13, wherein a minimum value of said acute angles of said second upper facets ranges from 15° to 60°.

17. The fastener according to claim 13, wherein a minimum value of said acute angles of said second upper facets is 30°.

18. The fastener according to claim 13, wherein a minimum value of said obtuse angles of said second lower facets ranges from 110° to 165°.

19. The fastener according to claim 13, wherein a minimum value of said obtuse angles of said second lower facets is 135°.

20. The fastener according to claim 13, wherein, for each said recess, an edge of said second upper facet proximate to said longitudinal axis is oriented parallel thereto.

21. The fastener according to claim 1, comprising three of said recesses.

22. The fastener according to claim 1, comprising four of said recesses.

23. The fastener according to claim 1, wherein each said recess further comprises a respective end wall extending between said first and second oppositely disposed side surfaces.

24. The fastener according to claim 1, wherein for each said recess a portion of said second side surface defines a single plane extending from a top opening of each said recess.

25. The fastener according to claim 24, wherein for each said recess said portion of said second side surface is oriented at an obtuse angle with respect to said floor surface.

26. The fastener according to claim 25, wherein a value of said obtuse angle of said second side surface ranges from 105° to 150°.

27. The fastener according to claim 25, wherein a value of said obtuse angle of said second surface is 120°.

28. A fastener, said fastener comprising:
a shaft having a coaxial longitudinal axis;
helical threads extending around at least a portion of said shaft;
a head mounted on said shaft, said head having a plurality of recesses extending outwardly from said longitudinal axis, each said recess being defined by first and second oppositely disposed side surfaces, and a floor surface extending therebetween, wherein for each said recess, said first side surface comprises:
a first lower facet contiguous with said floor surface, said first lower facet being oriented at an obtuse angle relatively to said floor surface;
a first upper facet extending between said first lower facet and a top opening of said recess, said first upper facet being oriented at an acute angle relatively to said floor surface; and
for each said recess said second side surface comprises:
a second lower facet contiguous with said floor surface, said second lower facet being oriented at an obtuse angle relatively to said floor surface;
a second upper facet extending between said second lower facet and said top opening of said recess, said second upper facet being oriented at an acute angle relatively to said floor surface.

29. The fastener according to claim 28, wherein said acute angles for said first and second upper facets vary with distance from said longitudinal axis.

30. The fastener according to claim 29, wherein said acute angles for said first and second upper facets become smaller with increasing distance from said longitudinal axis.

31. The fastener according to claim 29, wherein a minimum value of said acute angles for said first and second upper facets ranges from 15° to 60°.

32. The fastener according to claim 29, wherein a minimum value of said acute angles for said first and second upper facets is 30°.

33. The fastener according to claim 28, wherein a minimum value of said obtuse angles for said first and second lower facets ranges from 110° to 165°.

34. The fastener according to claim 28, wherein a minimum value of said obtuse angles for said first and second lower facets is 135°.

35. The fastener according to claim 28, wherein said floor surface is angularly oriented with respect to said longitudinal axis.

36. The fastener according to claim 35, wherein said floor surface has an orientation angle ranging from 50° to 90°.

37. The fastener according to claim 35, wherein said floor surface has an orientation angle of 70°.

38. The fastener according to claim 28, wherein for each said recess, said floor surface has a first width proximate to said longitudinal axis and a second width distal to said longitudinal axis, said second width being greater than said first width.

39. The fastener according to claim 29, wherein, for each said recess, an edge of said first upper facet proximate to said longitudinal axis is oriented parallel thereto and an edge of said second upper facet proximate to said longitudinal axis is oriented parallel thereto.

40. The fastener according to claim 28, comprising three of said recesses.

41. The fastener according to claim 40, wherein said recesses are distributed about said longitudinal axis at angles of 120° from one another about said longitudinal axis.

42. The fastener according to claim 28, comprising four of said recesses.

43. The fastener according to claim 42, wherein said recesses are distributed about said longitudinal axis at angles of 90° from one another about said longitudinal axis.

44. The fastener according to claim 28, wherein each said recess further comprises a respective end wall extending between said first and second oppositely disposed side surfaces.

45-48. (canceled)

50. The method according to claim 49, further comprising:
deforming said second side surfaces of each of said recesses such that each said second side surface comprises:
a second lower facet contiguous with said floor surface, said second lower facet being oriented at an obtuse angle relatively to said floor surface;
a second upper facet extending between said second lower facet and said top opening of said recess, said second upper facet being oriented at an acute angle relatively to said floor surface.

51. The method according to claim 49, wherein said deforming said first side surfaces of said recesses comprises compressing said head along said longitudinal axis using a tool while rotating said tool about said longitudinal axis in a first direction.

52. The method according to claim 50, wherein:
said deforming said first side surfaces of said recesses comprises compressing said head along said longitudinal axis using a first tool while rotating said first tool about said longitudinal axis in a first direction; and
said deforming said second side surfaces of said recesses comprises compressing said head along said longitudinal axis using a second tool while rotating said second tool about said longitudinal axis in a second direction opposite to said first direction.

53. The method according to claim 49, further comprising forming a plurality of helical threads around at least a portion of said shaft.
